(19) United States
(12) Patent Application Publication
(10) Pub. No.: US 2003/0035589 A1
(43) Pub. Date: Feb. 20, 2003

(54) Quantization/dequantization method by making dynamic adaptive table and apparatus thereon

(75) Inventor: Jeong Woo Kim, Seoul (KR)

Correspondence Address: JONATHAN Y. KANG, ESQ., LEE & HONG P.C., 221 N. Figueroa Street, 11th Floor, Los Angeles, CA, 90012-2601, US

(73) Assignee: LG Electronics Inc.

(21) Appl. No.: 10/119,658

(22) Filed: Apr. 10, 2002

(30) Foreign Application Priority Data
Jun. 14, 2001 (KR) 33421/2001

(51) Int. Cl. G06K 9/36

(52) U.S. Cl. 382/239

(57) ABSTRACT

The present invention relates to a quantization/dequantization method by making a dynamic adaptive table and an apparatus thereon. The present invent provides a quantization method by making a dynamic adaptive table, the method including the steps of: extracting complexity of randomly inputted visual data; generating a quantization table having a lower coefficient value for a high frequency in the quantization table as a degree of the extracted complexity gets higher; and transmitting the visual data after performing a discrete cosine transform process and a quantization process by the quantization table upon the visual data.

### BACKGROUND OF THE INVENTION

1. Field of the Invention

The present invention relates to a quantization/dequantization method by making a dynamic adaptive table and an apparatus thereon. In particular, the present invention relates to a quantization/dequantization method by making a dynamic adaptive table, which enables to make an optimal quantization table for visual data individually, and to apply the table to data transmission.

2. Description of the Related Art

Media industry, originally started from printing media, has been kept abreast of rapid progress of techniques associated with Internet, and high definition televisions (HDTV) and visual telephones, so the center of the media industry is no longer characters like hyper text, but visual data like animation or images.

Regretfully though, the visual data is somewhat inefficient in terms of performance and price, especially when a great volume of data is to be stored and transmitted using a general method. Therefore, a more efficient method for using the visual data is being studied by trying to compress the data before transmission, and reconstitute the transmitted data later.

A typically used process during the compression and reconstitution of the visual data is a quantization process in which the compression ratio is determined. The traditional quantization method and apparatus will be now explained below.

FIG. 1 is a block diagram of a coder in the prior art, and FIG. 2 diagrammatically shows a moving picture experts group (MPEG) intra quantization table in the prior art.

Referring to FIG. 1, the method for visual data compression according to the prior art is explained.

When visual data is randomly inputted, a complexity calculator 110 calculates the complexity of the random visual data and transmits the result to a quantizer 140. Also, a discrete cosine transform processor 120 conducts the discrete cosine transformation process on the inputted visual data, divides the data into a low frequency band and a high frequency band, and transmits them to the quantizer 140.

On the other hand, the quantizer 140, based on designated index information the complexity calculator 110 and a code generation amount controller 130, detects a quantization coefficient value in the pre-made quantization table as shown in FIG. 2.

FIG. 3 is a block diagram showing a quantizer using a plurality of quantization tables.

Similar to the method shown in FIG. 3, Korean Patent Application No. 10-1992-013568 disclosed a method, in which various kinds of visual data is analyzed to experimentally generate several representative quanta and tables therefrom, and a coder and a decoder, respectively, promise a quantum and a table value, and finally the quantum and the table index selected during a coding process are transmitted.

The disclosed method is more advanced than the prior art with one single quantization table in that it uses a plurality of quantization tables to treat diverse visual data separately.

Nevertheless, the method has some defects that each visual data cannot be described in details, and that as the number of quanta and tables is increased, the bit rate of the transmitting index is also increased, consequently lowering the coding efficiency.

On the other hand, the method illustrated in FIG. 3 has an advantage that it can reconstitute even non-mutually promised-tables by transmitting the quantization table, which had been applied to the coder, together with bit streams. However, this method again has a problem that the bit rate corresponding to the quantization table increases by geometric progression as the quantization table itself gets transmitted.

In short, the methods described above are disadvantageous overall because they do not necessarily set definite standards for the table implementation method, but instead they only deteriorated picture quality by increasing the bit rate due to overhead.

As an attempt to solve the problems, recent researches are not putting more emphasis on fixating the quantization table with recommendable values and improving an mquant value for use of the quantizer in the quantization table (see the reference numeral 140 in FIG. 1).

Although these methods use the same method for extracting parameter from the viewpoint that all of them take advantage of visual characteristics of a human by separating high frequencies from low frequencies in a frequency domain, it does not mean that they are very useful because the quantization table value in each method is fixed, meaning that, when the fixed value is applied to actual visual data, it is equally applied to the low frequencies and the high frequencies. In result, the visual data becomes without much characteristics.

### SUMMARY OF THE INVENTION

It is, therefore, an object of the present invention to provide a quantization/dequantization method by making a dynamic adaptive table and an apparatus thereon, in which the dynamic adaptive table is applicable to individual consecutive visual data by making different quantization tables appropriate for different visual data, respectively.

To achieve the above object, there is provided a quantization method by making a dynamic adaptive table, the method including the steps of: extracting complexity of randomly inputted visual data; generating a quantization table having a lower coefficient value for a high frequency in the quantization table as a degree of the extracted complexity gets higher; and transmitting the visual data after performing a discrete cosine transform process and a quantization process by the quantization table upon the visual data.

$$q ( u , v ) = \frac{1}{1 + {σ}^{′} {ⅇ}^{- γ ( \sqrt{{u}^{2} + {v}^{2}} - center )}}$$

Also, there is provided a quantization/dequantization method by making a dynamic adaptive table, the method comprising the steps of generating coefficient values of a quantization table based on a following equation, generating a quantization table by scaling the coefficient values of the quantization table based on a following equation,

$$Q ( u , v ) = \frac{( {f}_{U} - {f}_{L} )}{( {f}_{2} - {f}_{1} )} \times ( q ( u , v ) - {f}_{1} ) + {f}_{L}$$

quantizing coefficient values based on a following equation,

$$\hat{F} ( u , v ) = round ( \frac{F ( u , v )}{Q ( u , v ) \times mpuant} )$$

wherein the coefficient values have been discrete cosine transformed according to the scaled quantization table, and transmitting the quantized coefficient values; and

dequantizing a quantized transmission signal based on a following equation to regenerate the transmission signal,

\tilde{F}(u,v)=\hat{F}(u,v)×Q(u,v)×xmquant

wherein F(u, v) are coefficient values after a transform coding process involving a discrete cosine transform; the mquant is a quantization step size; f₁ is a minimum coefficient value in the quantization table; f₂ is a maximum coefficient value in the quantization table; f_{L} is a maximum quantized coefficient value after scaling the quantization table; and f_{U} is a minimum quantized coefficient value after scaling the quantization table.

In addition, the present invention provides a quantization/dequantization apparatus by making a dynamic adaptive table, the apparatus including: a complexity calculator for extracting a complexity of randomly inputted visual data; a discrete cosine transform processor for performing a discrete cosine transform process on the randomly inputted visual data; a code generation amount controller for maintaining an amount of data storage of a buffer to a specific level, for adjusting a coefficient value of a quantization table to a constant ratio, and for controlling a quantization step size; a quantizer for generating an appropriate quantization table for the randomly inputted visual data, based on the calculated complexity using the complexity calculator and/or the calculated quantization step size using the code generation amount controller, and for quantizing designated visual data provided by the discrete cosine transform processor through the generated quantization table; an entrophy coder for coding the quantized visual data; an inverse entrophy coder for applying a complexity of the visual data, which is restored from a signal transmitted from the coder through a channel, to generation of a quantization table; a dequantizer for dequantizing the transmitted signal using the generated quantization table; and a inverse discrete cosine transform processor for performing a discrete cosine transform process on a dequantized transmission signal and for regenerating the transmission signal to a picture or image.

### BRIEF DESCRIPTION OF THE DRAWINGS

The above objects, features and advantages of the present invention will become more apparent from the following detailed description when taken in conjunction with the accompanying drawings, in which:

FIG. 1 is a block diagram of a coder in the prior art;

FIG. 2 diagrammatically shows a MPEG intra quantization table in the prior in the prior art;

FIG. 3 is a block diagram of a quantizer using a plurality of quantization tables;

FIG. 4 is a block diagram of a coder in accordance with a preferred embodiment of the present invention; and

FIG. 5 is a block diagram of a decoder in accordance with a preferred embodiment of the present invention.

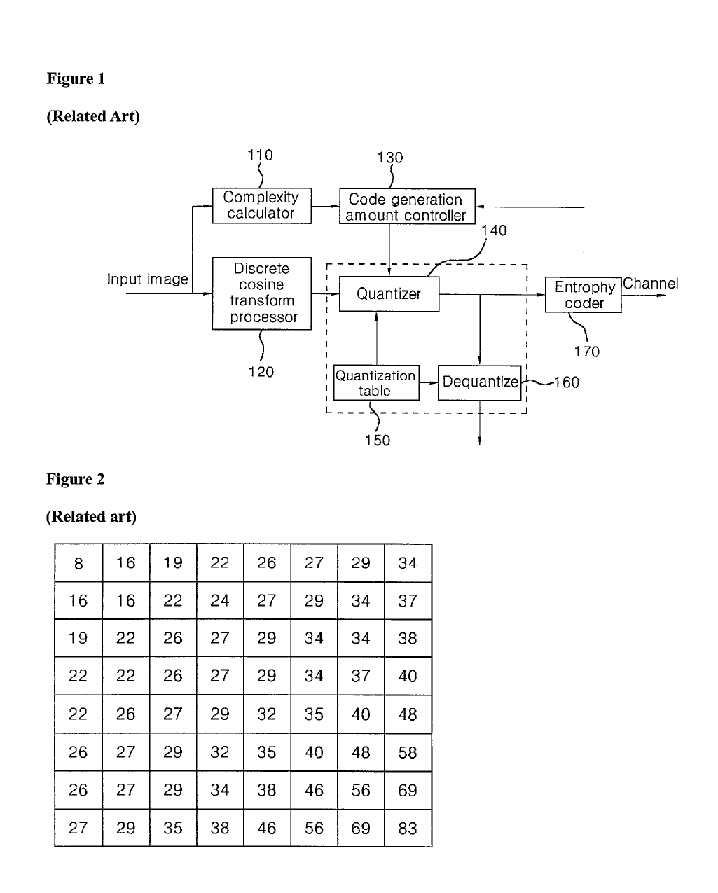

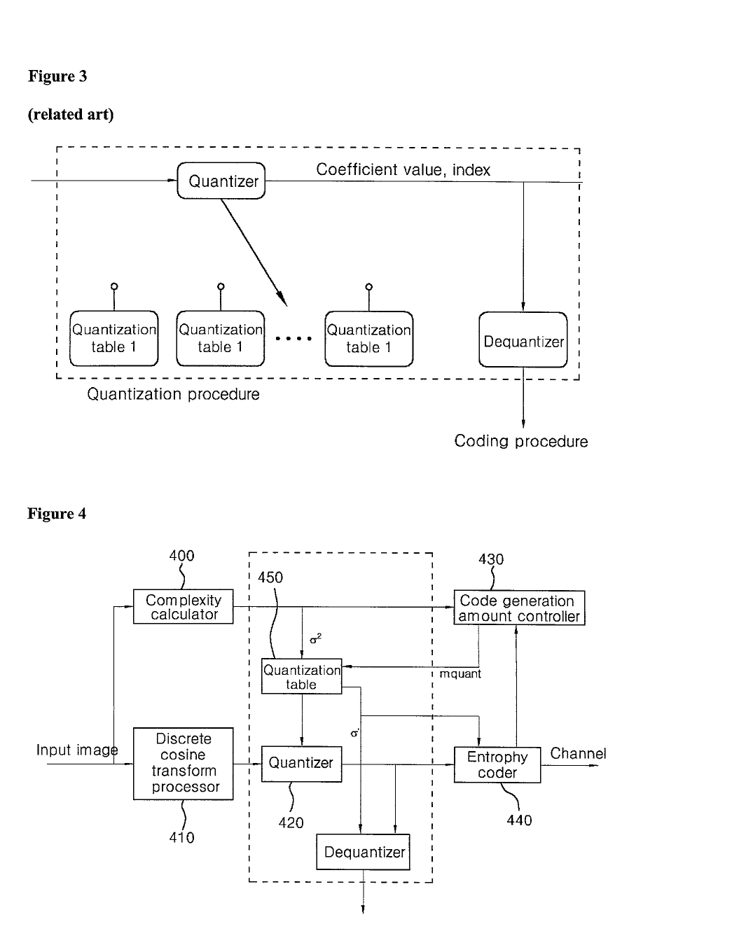

### DETAILED DESCRIPTION OF THE PREFERRED EMBODIMENT

A preferred embodiment of the present invention will now be described with reference to the accompanying drawings. In the following description, same drawing reference numerals are used for the same elements even in different drawings. The matters defined in the description focus on those that will assist in a comprehensive understanding of the invention. Thus, well-known functions or constructions are not described in detail since they would obscure the invention in unnecessary detail.

FIG. 4 is a block diagram of a coder in accordance with a preferred embodiment of the present invention.

With reference to FIG. 4, the coder includes a complexity calculator 400 for calculating a complexity of visual data in order to generate a dynamic adaptive quantization table according to the visual data, a discrete cosine transform processor 410 for performing a discrete cosine transform process on the inputted visual data and dividing the transformed data into a high frequency component and a low frequency component, a quantizer 420 for quantizing the inputted visual data, an entrophy coder for confirming compression degree of the visual data from the quantizer 420 and for transmitting a transmission signal to an outside, and a code generation amount controller 430 for generating a quantization step size (mquant) value based on the complexity that is transmitted from the complexity calculator 400 and the compression degree that is transmitted from the entrophy coder 440.

To more specifically explain the functions of the blocks, first of all, the complexity calculator 400 calculates the complexity for extracting a specific parameter out of the randomly and consecutively inputted visual data.

The discrete cosine transform processor 410 partitions the pixels of the randomly inputted visual data into square blocks, and disproportionately transforms the visual data in a pixel block unit by putting low frequency component visual data on an upper left side and high frequency component visual data on a lower right side.

More preferably, the high frequency component without a lot of influences upon vision, that is, the unnecessary visual data of the high frequency positioned on the lower right side of the discrete cosine transformed visual data, can be disregarded to compress the visual data more efficiently.

In the meantime, a designated quantization table 450 is generated based on the complexity, which is calculated by the complexity calculator 400, and the quantization step size (mquant), which is calculated by the code generation amount controller 430, even though the complexity calculator 400 is, in fact, not that necessary to the present embodiment since it has no influence upon the essential effect of the present invention in any way.

The quantizer 420 quantizes the random visual data according to the generated quantization table 450.

The code generation amount controller 430 controls the quantization step size (mquant) to maintain a specific amount of the data storage in the buffer (not shown). In addition, the code generation amount controller 430 reflects the controller mquant on the quantization table in order to generate a higher compression ratio.

The entrophy coder 440 varies the quantization step size (mquant) by controlling the code generation amount controller 430 according to the compression ratio, and quantizes the signal from the discrete cosine transform processor 410 in a different way. Further, the entrophy coder 440 directly transmits the quantized signal to generate a channel transmission code.

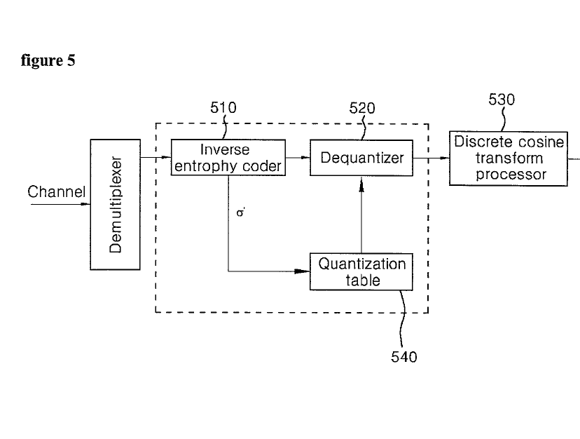

FIG. 5 is a block diagram partially showing a decoder according to a preferred embodiment of the present invention.

Referring to FIG. 5, the decoder for implementing the quantization method by making a dynamic adaptive table according to the present invention includes an inverse entrophy coder 510, a dequantizer 520, and an inverse discrete cosine transform processor 530.

More specifically speaking, the inverse entrophy coder 510 assists generation of the quantization table 540 by reconstituting a relevant value to the complexity of the visual data, that is, σ′, among other signals that are transmitted from the coder through a channel.

Meanwhile, the σ′ value can be generated directly from the transmitted signals.

In addition, the dequantizer 520 dequantizes the transmission signals by carrying out a totally opposite procedure to the quantization procedure that is performed by the quantizer of the coder (see the reference numeral 420 in FIG. 4) using the reconstituted quantization table 540.

The dequantized transmission signals undergo the inverse discrete cosine transformation in the inverse discrete cosine transform processor 530 and are regenerated into pictures or images.

Next, the quantization method using a quantizer to make a dynamic adaptive table according to the present invention is explained in details.

To begin with, when an arbitrary pixel block among the randomly inputted visual data, that is, a code word, is inputted, the discrete cosine transform processor (see the reference numeral 410 in FIG. 4) (Forward DCT), based on the spatial frequency characteristics of the visual data, disproportionately distribute the low frequency component and the high frequency component to the upper left side and the lower right side, respectively. For example, the coefficient for (0,0) coordinate in the block having a transformed frequency indicates a DC component.

On the other hand, applying the mathematical equation I illustrated below, the complexity of the randomly inputted visual data into the complexity calculator (see the reference numeral 400 in FIG. 4) can be extracted.

$${σ}^{′} = \frac{1}{10} \sqrt{\frac{n \sum {f}^{2} ( x ) - {( \sum f ( x ) )}^{2}}{n ( n - 1 )}} \qquad ⟨ Mathematical Equation I ⟩$$

Here, the complexity is a scale-downed value, namely, one tenth of a standard deviation. The value is dependent on the pixel value (x) and the number of pixels (n) within a block. One thing to be aware of is that the σ′ obtained from the equation I is just an exemplary value that makes it possible to estimate the complexity, and even if a variance or normal standard deviation can be used instead of the σ′, it does not bring any substantial effect on the present invention.

In the meantime, the complexity is closely related to the frequency characteristics. That is, a high complexity value indicates a high frequency with many variations, while a low complexity value indicates a low frequency with few variations.

Afterwards, a designated quantization table is generated with reference to the complexity. The following illustrates an equation for generating the quantization table.

$$q ( u , v ) = \frac{1}{1 + {σ}^{′} {ⅇ}^{- γ ( \sqrt{{u}^{2} + {v}^{2}} - center )}} \qquad ⟨ Mathematical Equation II ⟩$$

Here, the center means the center of the block. For instance, in case of an 8×8 matrix, the correction value for shifting the quantization table having the center at (0,0) to the center of the 8×8 matrix will be \sqrt{3.5²+3.5²}, or \sqrt{24.5}. Also, γ is the slope at the boundary between the low frequency component and the high frequency component. According to the experiment, the most desirable value for γ ranges from 0.5 to 1.2.

Meanwhile, the equation II can be rewritten to one-dimensional equation as shown in the exemplary equation below.

$${q}^{′} ( u ) = \frac{1}{1 + {σ}^{′} {ⅇ}^{- γ ( u - center )}} \qquad ⟨ Mathematical Equation III ⟩$$

The trouble of transforming the equation for generating the quantization table into one dimension is that sometimes the visual data might not be compressed as precise as much. However, considering the primary object of the present invention, that is, to designate different quantization tables in the low frequency and in the high frequency, the data compression problem aforementioned will not affect the present invention in any way.

The σ′ in the equations II and III, sets the boundary between the high frequency and the low frequency. More specifically, as σ′ increases, the distribution of the quantization table shifts towards the high frequency, and assigns a low quantization value throughout a broad domain overall, based on the DC value within the block, coding a narrow domain only based on that DC value. Therefore, most high frequency components take zero (0), which consequently increases the coding efficiency and decreases the bit rate.

As explained before, γ indicates the slope at the boundary of the low frequency and the high frequency. For example, the smaller the γ value is, the gentler the slope is. Also, an appropriately small γ value can decrease any error that can be generated around the boundary of the quantization table value. Especially when the γ value is zero the equations II and III become 1/(1+σ′), a linear quantizer. The gentle slope means that it includes a large number of high frequency components, not much reflecting the visual characteristics of people.

Once the quantization table is generated based on the mathematical equations II and III, it is scaled. This scaling procedure is accomplished through the following equation.

$$Q ( u , v ) = \frac{( {f}_{U} - {f}_{L} )}{( {f}_{2} - {f}_{1} )} \times ( q ( u , v ) - {f}_{1} ) + {f}_{L} \qquad ⟨ Mathematical Equation IV ⟩$$

To explain the equation more specifically, the value for q (u, v) is obtained from the equation II, and f₁ and f₂ are the minimum coefficient and the maximum coefficient of the quantization table, which can be calculated using the equation II. Also, f_{L} and f_{U} are the maximum value and the minimum value out of object values to be scaled.

More explicitly, the f_{L} and f_{U} can be designated as 8 and 83, respectively, as shown in the conventional quantization table of FIG. 2. The scaling procedure is included here because the quantization table vales the equations II and III can derive only ranges from 0 to 1, which, in general, is not appropriate for an actual application.

However, there is no definite limit on the range of values regarding the maximum coefficient and the minimum coefficient of the quantization table, as long as the minimum value is greater than 1. More preferably, the maximum and the minimum had better be an integral number.

After that, to get rid of the high frequency components of the disproportionately distributed visual data, the components having been scattered in different parts of domain, to an appropriate level according to the screen, the quantizer 420 quantizes the high frequency components by the pre-generated quantization table (see the reference numeral 450 in FIG. 4). Although such quantization procedure may vary depending on the visual data, mostly the low frequency components survive in the quantized visual data before the data is outputted.

After the scaled quantization table is generated based on the equation IV, the following equation is used for quantizing the table.

$$\hat{F} ( u , v ) = round ( \frac{F ( u , v )}{Q ( u , v ) \times mpuant} ) \qquad ⟨ Mathematical Equation V ⟩$$

Here, F(u, v) indicates coefficients after transform coding through the discrete cosine transformation by the equations II and III. Q(u,v) is, on the other hand, a quantization table generated using the equation IV. Also, the quantization step size (mquant) can be obtained by the code generation amount controller (see the reference numeral 430 in FIG. 4), which adjusts the coefficients of the quantization table collectively. Lastly, F(u,v) is a transmission signal of the finally quantized visual data.

In the meantime, for dequantization at the decoder, the σ′, which has been used for generating the quantization table, is transmitted together with image data by the entrophy coder 440.

Moreover, the visual data with the low frequency components only is coded by the entrophy coder (see the reference numeral 440 in FIG. 4), and is transmitted via designated channel.

On the other hand, the transmission signal from the entrophy coder (see the reference numeral 440 in FIG. 4) is dequantized going through the procedure shown in the equation below.

\tilde{F}(u,v)=\hat{F}(u,v)×Q(u,v)×mquant <Mathematical Equation VI>

Similar to the equation IV, the \hat{F}(u,v) is a transmission signal that is transmitted from the coder, and the Q(u, v) indicates the quantization table 540 that is generated by the quantization procedure. Further, the mquant is the quantization step size, and the same quantization step size applied to the quantization table generation procedure is used here as well so that it can be reconstituted to an original value by dequantization.

According to another aspect of the present invention, the σ′ value does not need to be transmitted from the coder to the decoder, but is extracted directly from the data that is transmitted from the inverse entrophy coder 510. In this case, even though the resulting image can be slightly different from the actual image, since the transmitting data rate is decreased, the bit rate overhead can be decreased as well.

In conclusion, the quantization/dequantization method by making a dynamic adaptive table and an apparatus thereon according to the present invention are very advantageous in that they enable to generate an optimal quantization table arbitrarily for any randomly inputted visual data, so when applied, it can optimize the visual data compression ratio for each visual data.

Also, infinite number of appropriate quantization tables can be generated for certain visual data. Thus, it becomes more convenient to apply the quantization tables to a variety of images.

When applying the appropriately generated quantization tables, the bit rate is decreased by getting rid of the high frequency domain in the image data more effectively. As a further result, peak signal to noise ratio (PSRN) is improved and the data compression ratio is also improved.

In addition, it is known that by additionally applying the quantization step size (mquant) to a quantization table generation procedure, the compression ratio can be even more increased.

Lastly, when more transmission bits are assigned to a frequency domain that is relatively more sensitive to a human's vision, the measure of evaluation on the image one personally senses can be improved.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A quantization method by making a dynamic adaptive table, the method comprising the steps of:
extracting complexity of randomly inputted visual data;
generating a quantization table having a lower coefficient value for a high frequency in the quantization table as a degree of the extracted complexity gets higher; and
transmitting the visual data after performing a discrete cosine transform process and a quantization process by the quantization table upon the visual data.

2. The method of claim 1, further comprising the step of performing an entrophy coding on the quantized visual data and transmitting the coded data.

3. The method of claim 1, wherein coefficient values of the entire quantization table can be adjusted by a quantization step size (mquant).

4. The method of claim 1, wherein the complexity is a value corresponding to 1/10 of a standard deviation.

5. The method of claim 1, wherein the complexity is a standard deviation or a variance.

6. The method of claim 1, wherein the quantization table improves visual characteristics by including more high frequency components as a slope at a boundary between a low frequency and a high frequency gets smaller.

7. The method of claim 1, wherein after the quantization table is generated, coefficient values in the quantization table are scaled to be in a range between a designated minimum coefficient value and a designated maximum coefficient value, before quantizing the visual data.

8. The method of claim 7, wherein the minimum coefficient value is at least greater than 1.

9. A quantization method by making a dynamic adaptive table, the method comprising the steps of:
generating a quantization table based on a following equation,
$$q ( u , v ) = \frac{1}{1 + {σ}^{′} {ⅇ}^{- γ ( \sqrt{{u}^{2} + {v}^{2}} - center )}}$$
wherein, σ′ is a complexity; γ is a slope value at a boundary between a low frequency and a high frequency; and center is a center of a block;
quantizing discrete cosine transformed visual data according to the quantization table; and
compressing the quantized visual data; and
transmitting the compressed data.

10. The method of claim 9, wherein the γ is in a range of from 0.5 to 1.2.

11. The method of claim 9, wherein the quantization table is scaled based on a following equation,
$$Q ( u , v ) = \frac{( {f}_{U} - {f}_{L} )}{( {f}_{2} - {f}_{1} )} \times ( q ( u , v ) - {f}_{1} ) + {f}_{L}$$
wherein, f₁ is a minimum coefficient value in the quantization table; f₂ is a maximum coefficient value in the quantization table; f_{L} is a maximum quantized coefficient value after scaling the quantization table; and f_{U} is a minimum quantized coefficient value after scaling the quantization table.

12. The method of claim 9, wherein σ′ is transmitted to be used as the complexity in a coding procedure.

13. The method of claim 9, wherein the complexity is generated directly out of transmitted visual data from a coder.

14. A quantization/dequantization method by making a dynamic adaptive table, the method comprising the steps of:
generating coefficient values of a quantization table based on a following equation,
$$q ( u , v ) = \frac{1}{1 + {σ}^{′} {ⅇ}^{- γ ( \sqrt{{u}^{2} + {v}^{2}} - center )}}$$
generating a quantization table by scaling the coefficient values of the quantization table based on a following equation,
$$Q ( u , v ) = \frac{( {f}_{U} - {f}_{L} )}{( {f}_{2} - {f}_{1} )} \times ( q ( u , v ) - {f}_{1} ) + {f}_{L}$$
quantizing coefficient values based on a following equation,
$$\hat{F} ( u , v ) = round ( \frac{F ( u , v )}{Q ( u , v ) \times mpuant} )$$
wherein the coefficient values have been discrete cosine transformed according to the scaled quantization table, and transmitting the quantized coefficient values; and
dequantizing a quantized transmission signal based on a following equation to regenerate the transmission signal,
\tilde{F}(u,v)=\hat{F}(u,v)×Q(u,v)×mquant
wherein F(u, v) are coefficient values after a transform coding process involving a discrete cosine transform; the mquant is a quantization step size; f₁ is a minimum coefficient value in the quantization table; f₂ is a maximum coefficient value in the quantization table; f_{L} is a maximum quantized coefficient value after scaling the quantization table; and f_{U} is a minimum quantized coefficient value after scaling the quantization table.

15. A quantization method by making a dynamic adaptive table, the method comprising the steps of:
generating a quantization table based on a following equation,
$${q}^{′} ( u ) = \frac{1}{1 + {σ}^{′} {ⅇ}^{- γ ( u - center )}}$$
wherein, σ′ is a complexity; γ is a slope value at a boundary between a low frequency and a high frequency; and center is a center of a block;
quantizing discrete cosine transformed visual data according to the quantization table;
compressing the quantized visual data; and
transmitting the compressed data.

16. The method of claim 15, wherein the γ is in a range of from 0.5 to 1.2.

17. A quantization/dequantization apparatus by making a dynamic adaptive table, the apparatus comprising:
a complexity calculator for extracting a complexity of randomly inputted visual data;
a discrete cosine transform processor for performing a discrete cosine transform process on the randomly inputted visual data;
a code generation amount controller for maintaining an amount of data storage of a buffer to a specific level, for adjusting a coefficient value of a quantization table to a constant ratio, and for controlling a quantization step size;
a quantizer for generating an appropriate quantization table for the randomly inputted visual data, based on the calculated complexity using the complexity calculator and/or the calculated quantization step size using the code generation amount controller, and for quantizing designated visual data provided by the discrete cosine transform processor through the generated quantization table;
an entrophy coder for coding the quantized visual data;
an inverse entrophy coder for applying a complexity of the visual data, which is restored from a signal transmitted from the coder through a channel, to generation of a quantization table;
a dequantizer for dequantizing the transmitted signal using the generated quantization table; and
a inverse discrete cosine transform processor for performing a discrete cosine transform process on a dequantized transmission signal and for regenerating the transmission signal to a picture or image.
